(19) United States
(12) Patent Application Publication
(10) Pub. No.: US 2020/0193304 A1
(43) Pub. Date: Jun. 18, 2020

(54) MACHINE-IMPLEMENTED METHOD FOR RETRIEVAL OF PRIORITIZED DATA AND INSIGHT EXTRACTION THEREFROM

(71) Applicant: BigInfo Labs India Private Limited, Bangalore (IN)

(72) Inventors: Santhosh Adayikkoth, Bangalore (IN); Arun Kumar, Bangalore (IN)

(73) Assignee: BigInfo Labs India Private Limited, Bangalore (IN)

(21) Appl. No.: 16/714,735

(22) Filed: Dec. 14, 2019

(30) Foreign Application Priority Data
Dec. 14, 2018 (IN) 201843047370

(51) Int. Cl. G06N 5/02; G06F 16/906; G06F 16/9032; G06F 16/9035; G06F 16/9038

(52) U.S. Cl. CPC G06N 5/022; G06F 16/906; G06F 16/9038; G06F 16/9035; G06F 16/90328

(57) ABSTRACT

A machine-implemented method for retrieval of a set of prioritized data is described. The method includes the steps of obtaining a scope of analysis, prescribed either by a user or a system, feeding the scope of analysis in a machine through an user interface wherein, the machine is configured to augment the scope of analysis with a set of required information obtained by extracting relevant information from a preliminary data source, creating a corpus of data from at least one data source based on the augmented scope of analysis, processing the corpus of data by employing at least one parameter wherein, the at least one parameter is selected from at least one rule or a weightage based on the scope of analysis or a combination thereof to obtain a prioritized set of data. A machine-implemented method for extraction of insights from a set of prioritized data is also described.

### CROSS REFERENCE TO RELATED APPLICATIONS

This application claims priority from Indian patent application No. IN201843047370 filed on Dec. 14, 2018, which claims priority from Indian patent application no: IN201641043640 filed on Dec. 21, 2016.

### FIELD OF THE INVENTION

The present invention relates to a method for retrieval of a set of relevant data from large volumes of unstructured and semi-structured information. More specifically, the invention relates to a machine-implemented method for retrieval and ranking of a set of prioritized data.

### BACKGROUND OF THE INVENTION

Growth of most organizations such as pharmaceutical companies, consumer electronics companies, depends on innovation. Thus, for such companies, research and development is a critical area which has to be driven in an informed manner. To make informed decisions the companies need to execute various types of analysis for example, market analysis, competitor analysis, IP landscape analysis, freedom to operate etc. For such analysis the company needs to depend on insights from large volumes of information including unstructured and semi structured information like web articles, engineering & scientific journals, news items, patent documents etc.

Traditionally, these activities involve manual retrieval and analysis of documents from various sources including public worldwide web sources and information publishers. Manual analysis of large volumes of data can be intensive, repetitive, inefficient and cumbersome. Manual analysis is also prone to error as the number of documents to be read and analyzed are quite high. Users working in these areas are compelled to increase the coverage and scope of search as the cost of any oversight at this stage may be very high for the company.

One primary reason for the inefficiency is the lack of relevancy of the documents retrieved and shortlisted for analysis. This in turn depends on the way the documents are searched and retrieved for analysis. Typically, documents are retrieved using a search engine, where the user defines the set of search terms. A simple collection of search terms fails to capture the context and intent of analysis. Further, a bias is typically introduced in the search results due to misguided parameter weightings given to the search terms by the optimization practices of the search engine. Thus, the search will return many articles that may be irrelevant and directly compounding the burden of analysis. In addition, the search engine currently available provides results which are ranked based on the popularity or number of clicks, rather than knowledge of the subject. Some references are ranked higher in the result set due to sponsorship or advertising fees. Therefore, the documents that had been retrieved may be less relevant to the original scope and intent of analysis.

US patent application number US20140074811A1 describes a computer-implemented method for requesting a search using a query ranking model, so as to receive search results from the search engine, the search results being ordered in accordance with the query ranking model. U.S. Pat. No. 8,862,592B2 describes a method of searching data through an interactive graphical interface, identifying additional search parameters related to initial search parameters, generating a search space using all the initial and additional parameters, using adjustable weighting of the search parameters to provide an optimal search output. U.S. Pat. No. 8,862,592B2 describes a technique for query enrichment and the GUI for adjusting the weights of the query parameters. These approaches however, do not provide an opportunity to the user to express the area of analysis comprehensively as a cohesive set of parameters and depend on one or more arbitrarily chosen features to rank and order the results. Analysts typically perform their analysis in multiple iterations, where they fine tune their search based on their learnings from the previous iteration. These fine tuning and improvements too are manual and subjective. This increases the subjectivity in analysis.

Therefore there is a need to addresses the problem cited in the prior art by providing a better way of defining the area of analysis. Further, there is a need for techniques to extract the most relevant insights from the documents, which can improve the efficiency of the analysts and effectiveness of their analysis. There is also a need to prevent subjectivity in the analysis through automation or a mechanism to provide relevant guidance to the analysts to enrich the scope of analysis.

### OBJECTS OF THE INVENTION

An object of the invention is to provide a machine-implemented method of retrieval and ranking of a set of prioritized data.

Another object of the present invention is to provide a machine-implemented method of retrieval of a set of prioritized data using a concept model based information retrieval & analysis.

Another object of the invention is to provide a system and method for capturing and preserving the rich context of analysis, and extracting relevant insights, to improve the efficiency and accuracy of analysis.

Yet another object of the invention is to provide a system and method for capturing and preserving the rich context of analysis to improve the efficiency and accuracy of analysis.

Still another object of the invention is to provide a mechanism that can provide relevant guidance to the analysts to enrich the scope of analysis, and capture the rich context of the analysis—to improve its relevancy and thus ensure that the irrelevant documents that account for the noise of analysis are reduced.

### SUMMARY

One embodiment of the present invention refers to a machine-implemented method for retrieval of a set of prioritized data. The method includes the steps of obtaining a scope of analysis, prescribed either by a user or a system, feeding the scope of analysis in a machine through an user interface wherein the machine is configured to augment the scope of analysis with a set of required information obtained by extracting relevant information from a preliminary source, creating a corpus of data from at least one data source based on the augmented scope of analysis and processing the corpus of data by employing at least one parameter wherein, the at least one parameter is selected from at least one rule or a weightage based on the scope of analysis or a combination thereof to obtain a prioritized set of data.

Another embodiment of the present invention refers to a machine-implemented method for extraction of insights from a set of prioritized data. The method includes the steps of identifying at least one entity from the set of prioritized data, identifying at least one event from the set of prioritized data, identifying at least one relationship between two or more of the at least one entity, two or more of the at last one event, or a combination thereof, and presenting the at least one relationship.

Another embodiment of the present invention refers to a machine-implemented method for extraction of insights from a set of prioritized data. The method includes the steps of obtaining a scope of analysis, prescribed either by a user or a system, feeding the scope of analysis in a machine through a user interface wherein, the machine is configured to augment the scope of analysis with a set of required information to create an augmented scope of analysis, creating a corpus of data from at least one data source based on the augmented scope of analysis, processing the corpus of data employing at least one parameter, selected from at least one rule or a weightage based on the scope of analysis or a combination thereof to obtain a prioritized set of data, identifying at least one entity from the set of prioritized data, identifying at least one event from the set of prioritized data, identifying at least one relationship between two or more of the at least one entity, two or more of the at last one event, or a combination thereof, and presenting the at least one relationship.

### BRIEF DESCRIPTION OF THE DRAWINGS

FIG. 1 describes a process flow for retrieval of a set of prioritized data according to an embodiment of the present invention.

FIG. 2 describes a process flow for extraction of insights from a set of prioritized data according to an embodiment of the present invention.

FIG. 3 describes a process flow for method for extraction of insights from a set of prioritized data.

FIG. 4 describes a process flow for retrieval of a set of prioritized data according to an embodiment of the present invention.

FIG. 5 describes a process flow for retrieval of a set of prioritized data according to an embodiment of the present invention.

FIG. 6 describes a process flow for retrieval of a set of prioritized data according to an embodiment of the present invention.

FIG. 7 describes a process flow for retrieval of a set of prioritized data according to an embodiment of the present invention.

FIG. 8 describes a seventh process flow for retrieval of a set of prioritized data according to an embodiment of the present invention.

### DETAILED DESCRIPTION OF THE INVENTION

In the specification and the claims which follow, reference will be made to a number of terms which shall be defined to have the following meanings:

The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. “Substantially” means a range of values that is known in the art to refer to a range of values that are close to, but not necessarily equal to a certain value.

Other than in the examples or where otherwise indicated, all numbers or expressions referring to quantities of ingredients, reaction conditions, and the like, used in the specification and claims are to be understood as modified in all instances by the term “about.”

As used herein, the term “substantially” and its variations are defined as being largely but not necessarily wholly what is specified as understood by one of ordinary skill in the art.

One embodiment of the present invention refers to a machine-implemented method for retrieval of a set of prioritized data. The method includes the steps of obtaining a scope of analysis, prescribed either by a user or a system, feeding the scope of analysis in a machine through an user interface wherein the machine is configured to augment the scope of analysis with a set of required information obtained by extracting relevant information from a preliminary source. The method includes the step of creating a corpus of data from at least one data source based on the augmented scope of analysis and processing the corpus of data by employing at least one parameter. The at least one parameter is selected from at least one rule or a weightage based on the scope of analysis or a combination thereof to obtain a prioritized set of data.

Another embodiment of the present invention refers to a machine-implemented method for extraction of insights from a set of prioritized data. The method includes the steps of identifying at least one entity from the set of prioritized data, identifying at least one event from the set of prioritized data, identifying at least one relationship between two or more of the at least one entity, two or more of the at last one event, or a combination thereof, and presenting the at least one relationship. In an embodiment of the present invention, the step of extracting insights from the set of prioritized data includes the steps of identifying at least one relationship between the at least two entities identified from the set of prioritized data. In an embodiment of the present invention, the step of extracting insights from the set of prioritized data includes the steps of identifying at least one relationship between the at least two events identified from the set of prioritized data.

Another embodiment of the present invention refers to a machine-implemented method for extraction of insights from a set of prioritized data. The method includes the steps of obtaining a scope of analysis, prescribed either by a user or a system, feeding the scope of analysis in a machine through a user interface wherein, the machine is configured to augment the scope of analysis with a set of required information to create an augmented scope of analysis. The method includes the step of creating a corpus of data from at least one data source based on the augmented scope of analysis, processing the corpus of data employing at least one parameter to obtain a prioritized set of data. The at least one parameter is selected from at least one rule or a weightage based on the scope of analysis or a combination thereof. The method further includes the step of identifying at least one entity from the set of prioritized data, identifying at least one event from the set of prioritized data, identifying at least one relationship between two or more of the at least one entity, two or more of the at last one event, or a combination thereof, and presenting the at least one relationship.

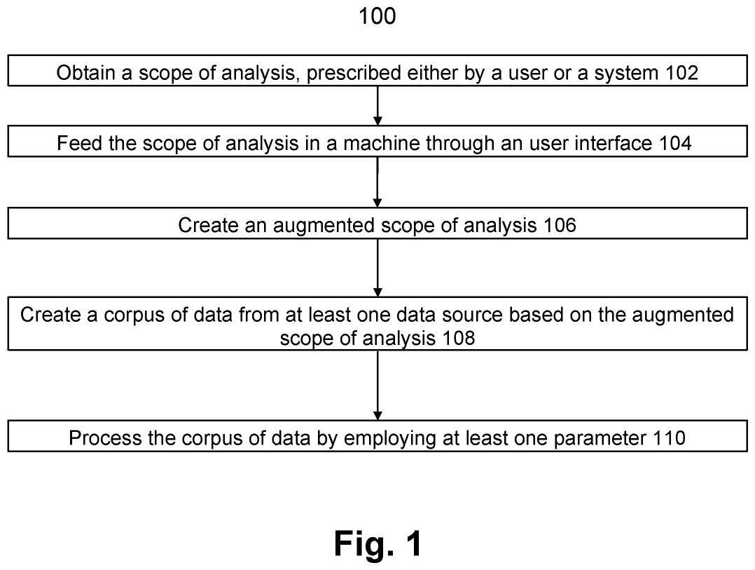

Referring now to FIG. 1, a process flow of a machine implemented method for retrieval of a set of prioritized data according to an embodiment of the present invention, is described. The machine implemented method 100 includes the following steps: obtaining 102 a scope of analysis, prescribed either by a user or a system, feeding 104 the scope of analysis in a machine through an user interface wherein the machine is configured to augment the scope of analysis with a set of required information obtained by extracting relevant information from a preliminary source, creating 106 an augmented scope of analysis, creating 108 a corpus of data from at least one data source based on the augmented scope of analysis, and processing 110 the corpus of data by employing at least one parameter. Typically, the at least one parameter is selected from at least one rule or a weightage based on the scope of analysis or a combination thereof to obtain a prioritized set of data.

In an embodiment of the present invention, the preliminary data source is at least one answer to at least one query directed to the user. In another embodiment of the present invention, the preliminary data source is at least one answer to at least one query directed to a database. In yet another embodiment of the present invention, the preliminary data source is a set of documents related to a first level query that defines the scope of analysis. In another one embodiment of the present invention, the preliminary data source is a set of documents provided by the user. In an embodiment of the present invention, the preliminary data source may refer to a set of documents retrieved based on the augmented scope of analysis. In another embodiment of the present invention, the preliminary data source may refer to a set of documents retrieved based on the first level query. In yet another embodiment of the present invention, the preliminary data source may refer to documents uploaded by the user.

In an embodiment of the present invention, the user may provide a high-level outline of the area of analysis. The system may use the high-level outline to retrieve documents from one or more sources and extract key terms and concepts that may be relevant to the current analysis. In one embodiment of the present invention the user may then use the extracted key terms and concepts to augment the scope of analysis.

In an embodiment of the present invention, the data source may include unstructured and semi structured information. In an embodiment of the present invention, the database may be the World Wide Web. In another embodiment of the present invention, the data source may be the World Wide Web, a data base, or a set of data given by the user. In yet another embodiment of the present invention, the data base may be a collection of a specific type of data, such as patents, research journal articles, business news, and the like. In an embodiment of the present invention, the corpus of data may refer to data extracted from the data source based on the augmented scope of analysis. In an embodiment of the present invention, the corpus of data may be dynamic or static or both. In one embodiment of the present invention, the data source may include unstructured and semi structured information like web articles, engineering & scientific journals, news items, patent documents, user-uploaded content, subscription based info and the like, in multiple formats.

In an embodiment of the present invention, the method further includes the step of fine-tuning the augmented scope of analysis. In another embodiment of the present invention, the step of fine-tuning the augmented scope of analysis is carried out by the system. In yet another embodiment of the present invention, the step of fine-tuning the augmented scope of analysis provides relevant guidance to the analyst to enrich the scope of analysis. In yet another embodiment of the present invention, the step of fine-tuning the augmented scope of analysis reduces the subjectivity of the analysis.

In an embodiment of the present invention, scope of analysis comprises a query, multilevel keywords, flexible keywords, or rules on sourcing. In an embodiment of the present invention, the scope of analysis may be expressed through multiple perspectives and multi-level keywords. The context of analysis may further be elaborated through weightages and rules. In an embodiment of the present invention, the augmented scope of analysis may be a multi-dimensional expression, a hierarchical property structure, a database or a collection of terms.

In an embodiment of the present invention, the machine may be a computer, a server, a smart phone, a tablet and the like.

In an embodiment of the present invention, the processing step involves at least one of ranking, annotation, classification, correlation, retrieval, entity and insight extraction or interactive analysis. In an embodiment of the present invention, the processing involves at least one of ranking of the documents or data in the corpus, their annotation, classification, correlation, retrieval, entity and insight extraction or interactive analysis.

In an embodiment, the present invention provides a system and method for capturing and preserving the context of analysis to improve the efficiency and accuracy of analysis performed. In one embodiment of the present invention the analysis so performed may help in supporting for example Research and Development activities, decision making at multiple industry verticals and functional areas and the like. An embodiment of the present invention is a system and method for improving the discovery and extraction of insights from large volumes of information including unstructured and semi structured information like web articles, engineering & scientific journals, news items, patent documents etc.

In an embodiment of the present invention, the machine-implemented method is a method that can capture the context of the analysis and improves the relevancy of the documents obtained and thus ensures that irrelevant documents that account for the noise of analysis are reduced. In another embodiment of the present invention, the context of analysis needs to be preserved and applied in retrieval, ranking and analysis of the documents. In one aspect, the invention looks into making the search broader across multiple categories.

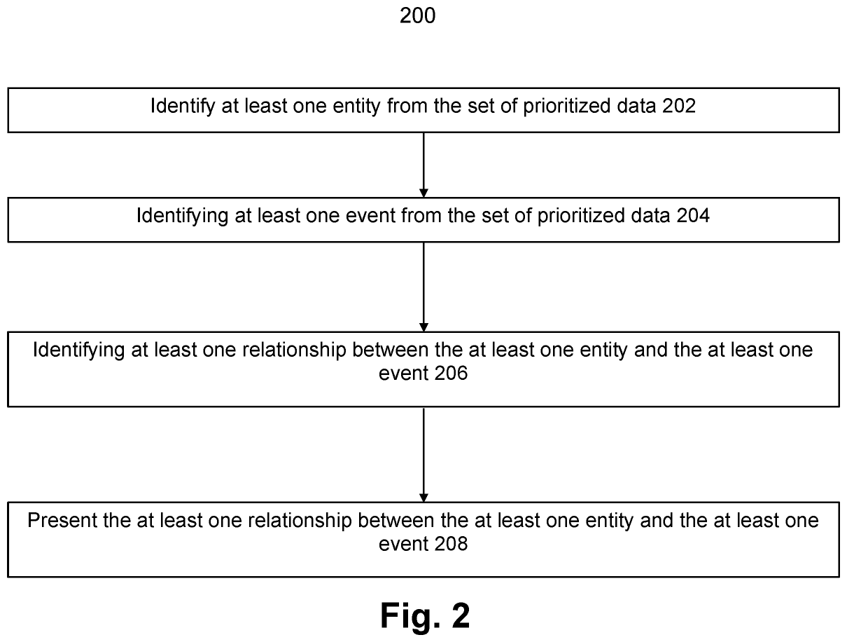

Referring to FIG. 2, a process flow for a method of extraction of insights from a set of prioritized data according to an embodiment of the present invention, is described. The method of extraction 200 includes the following steps: identifying 202 at least one entity from the set of prioritized data, identifying 204 at least one event from the set of prioritized data, identifying 206 at least one relationship between the at least one entity and the at least one event, and presenting 208 the at least one relationship between the at least one entity and the at least one event. In an embodiment of the present invention, the step of extracting insights from the set of prioritized data includes the steps of identifying at least one relationship between the at least two entities identified from the set of prioritized data. In an embodiment of the present invention, the step of extracting insights from the set of prioritized data includes the steps of identifying at least one relationship between the at least two events identified from the set of prioritized data.

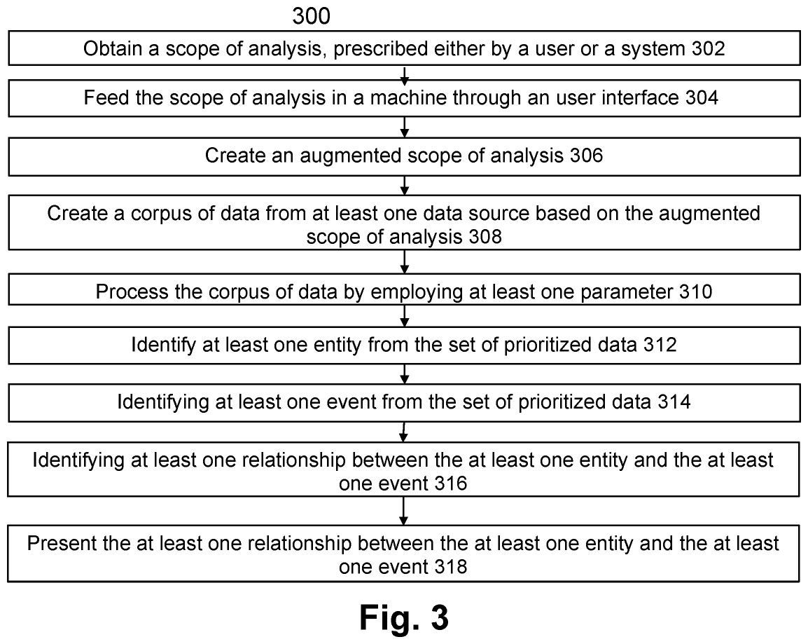

Referring now to FIG. 3, a process flow for method for extraction of insights from a set of prioritized data, according to an embodiment of the present invention, is described. The method 300 includes the steps of: obtaining 302 a scope of analysis, prescribed either by a user or a system, feeding 304 the scope of analysis in a machine through a user interface wherein, the machine is configured to augment the scope of analysis with a set of required information to create an augmented scope of analysis, creating 306 an augmented scope of analysis, creating 308 a corpus of data from at least one data source based on the augmented scope of analysis, processing 310 the corpus of data employing at least one parameter to obtain a prioritized set of data. The at least one parameter is selected from at least one rule or a weightage based on the scope of analysis or a combination thereof. The method 300 includes the step of identifying 312 at least one entity from the set of prioritized data, identifying 314 at least one event from the set of prioritized data, identifying 316 at least one relationship between the at least one entity and the at least one event; and presenting 318 the at least one entity, the at least one event and the at least one relationship between the at least one entity and the at least one event. In an embodiment of the present invention, the step of extracting insights from the set of prioritized data includes the steps of identifying at least one relationship between the at least two entities identified from the set of prioritized data. In an embodiment of the present invention, the step of extracting insights from the set of prioritized data includes the steps of identifying at least one relationship between the at least two events identified from the set of prioritized data.

In an embodiment of the present invention, the method 300 further includes the step of extracting insights from the set of prioritized data. In one embodiment of the present invention the step of extracting insights from the set of prioritized data includes the steps of, identifying at least one entity from the set of prioritized data; identifying at least one event from the set of prioritized data, identifying at least one relationship between the at least one entity and the at least one event, and presenting the at least one relationship between the at least one entity and the at least one event. In an embodiment of the present invention, the step of extracting insights from the set of prioritized data includes the steps of identifying at least one relationship between the at least two entities identified from the set of prioritized data. In an embodiment of the present invention, the step of extracting insights from the set of prioritized data includes the steps of identifying at least one relationship between the at least two events identified from the set of prioritized data.

In an embodiment of the present invention, at least one entity comprises a person, an organization, a location, a product, a technology, a chemical, a material, a property of a material, a process, an application or a combination thereof. In an embodiment of the present invention, the at least one event comprises a business acquisition, a product launch, a plant opening, a merger, a business announcement, a research initiative, a collaboration, or a combination thereof. In an embodiment of the present invention, the step of presenting the at least one relationship comprises presenting a graphical representation of the at least one relationship, presenting a tabular representation of the at least one relationship, presenting a pictorial representation of the at least one relationship, a statistical representation of the at least one relationship, or combinations thereof.

In an embodiment of the present invention, the machine-implemented method is a computer-implemented method.

In an embodiment of the present invention, the set of required information to create an augmented scope of analysis is based on a multi-dimensional expression or a hierarchical property structure or a combination thereof.

In an embodiment of the present invention, the augmented scope analysis includes a concept model. As used herein the term “concept model” may include a multi-dimensional expression or hierarchical property structure. In general, a ‘concept model’ or “multi-dimensional expression” or “hierarchical property structure” may be used to represent the scope and intent of analysis and to preserve and apply the same during retrieval, ranking and analysis of unstructured and semi structured information from multiple sources to improve the efficiency and accuracy of analysis performed may help in supporting for example Research and Development activities, decision making at multiple industry verticals and functional areas and the like. In another embodiment of the present invention, the ‘concept model’ provides a data structure to translate and store the ‘mind map’ of what has to be analyzed, including the subject, the scope and intent of analysis that a user would have. Typically, the ‘concept model’ captures the multiple facets or perspectives of the subject and scope of analysis and their relative importance based on the intent of analysis. In an example embodiment of the present invention, the concept model is enriched by dictionaries, ‘industry ontologies’, user defined synonyms, machine extracted relevant terms from document repositories.

In an embodiment of the present invention, the concept model enables targeted and intelligent retrieval of a set of documents from various sources of data. Non-limiting examples of sources of data from where the documents could be retrieved include public worldwide web, internal document repositories of the organization and the documents from different publishers. In another embodiment, the present invention can enable a contextual ranking of the set of documents retrieved by employing a set of proprietary algorithms. The contextual ranking helps to identify relevant documents and thereby improves the efficiency and accuracy of analysis. In yet another embodiment of the present invention, the concept model enables an in-depth analysis of the set of documents and providing contextual insights to the user. Another embodiment of the invention is to a method for the user to construct the concept model based on his/her knowledge of the domain and scope of analysis. Yet another embodiment of the invention is to a method to provide ways to construct the concept model from a document or a set of documents provided by the user. In another embodiment of the present invention, the construction of the concept model from a document or a set of documents may be automatic.

In an embodiment of the present invention, the method includes the step of creating a corpus of data from at least one data source based on the augmented scope of analysis. The corpus of data may be dynamic, static, or both. In one embodiment of the present invention, the data source may include unstructured and semi structured information like web articles, engineering & scientific journals, news items, patent documents, user-uploaded content, subscription based info and the like, in multiple formats.

In an embodiment of the present invention, the method for retrieval of a set of prioritized data includes the step of processing the corpus of data by employing at least one parameter. In another embodiment of the present invention, the processing can include steps not limited to ranking, annotation, classification, topic mining, correlations, retrieval, entity and insight extraction and interactive analysis. In one embodiment of the present invention, the at least one parameter could be provided either by the user, the system or both the user and the system. In an example embodiment of the present invention, the at least one parameter is selected from at least one rule or a weightage based on the scope of analysis to obtain a prioritized set of data. In another example embodiment of the present invention, the rules can be of a single level or of multilevel nature.

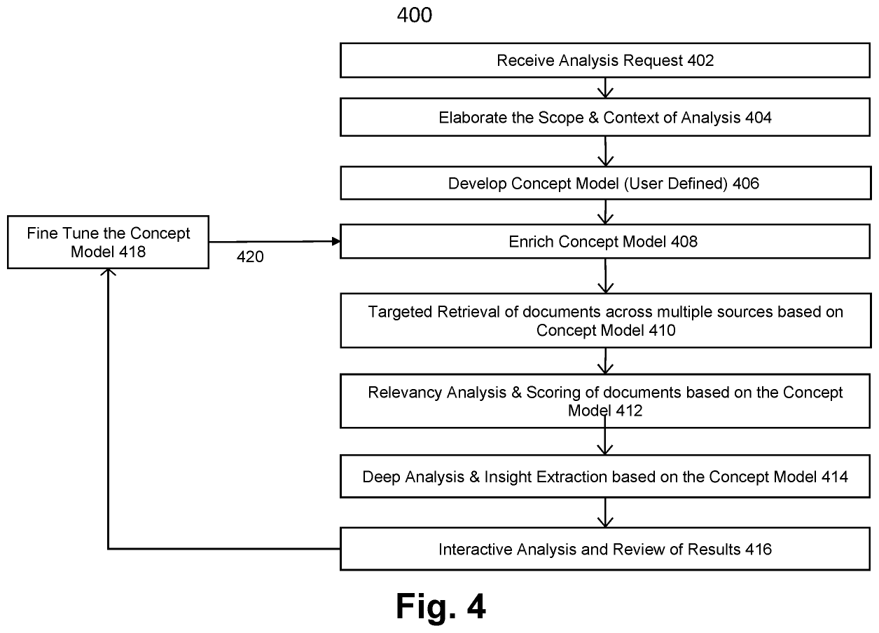

Referring now to FIG. 4, according to an embodiment of the invention, a machine-implemented method 400 for retrieval of a set of prioritized data. The method includes the steps of receiving 402 a request from a user or an analyst, elaborating 404 the scope and context of the analysis 404, developing 406 a concept model, enriching 408 the concept model, retrieving 410 of documents across multiple sources based on concept model, analyzing 412 relevancy and scoring of a set of documents based on the concept model, deep analysis and insight extraction based on the concept model 414, analyzing and reviewing 416 result, in case result not found to be proper, then fine-tuning 418 the concept model and then start again from step 410.

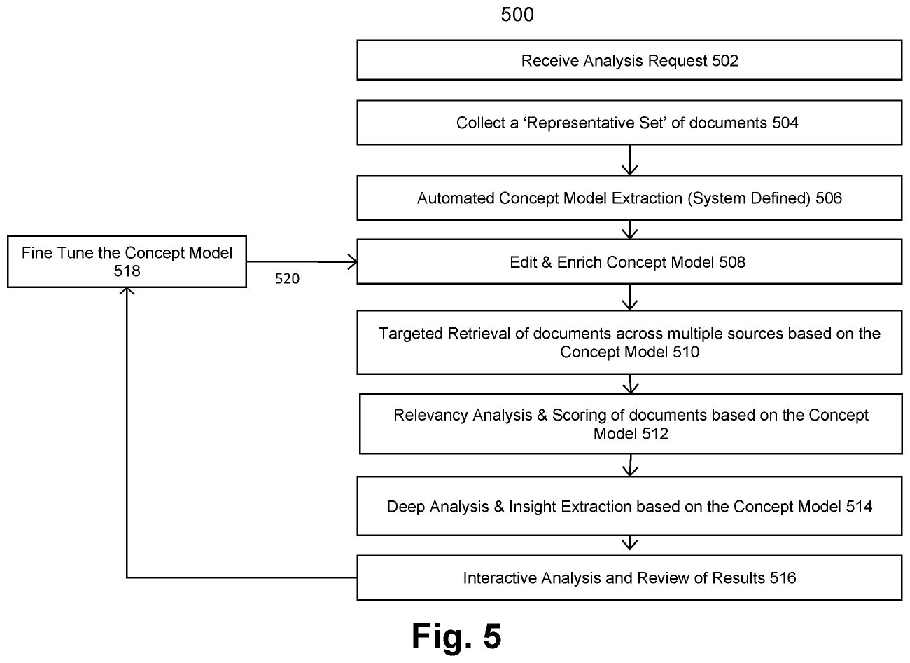

Referring now to FIG. 5, according to an embodiment of the invention, a machine-implemented method 500 for retrieval of a set of prioritized data. The method includes the steps of receiving 502 a request from a user/analyst, creating 504 a representative set of documents, extracting 506 an automated concept model. The method includes the step of editing 508 the concept model. In one embodiment of the present invention the editing 508 of the concept model may further include the step of enriching of the concept model. The method 500 includes the step of targeted retrieval 510 of a set of documents across multiple sources based on concept model, analyzing 512 the relevancy of the set of documents based on concept model. The method 500 includes the step of analysis and extracting insights 514 based on the concept model, interactively analyzing and review 516 of result. The method 500 includes the step of fine-tuning 518 the concept model to obtain accurate results. In another embodiment of the present invention, the method 500, in case the result obtained are not found to be accurate, includes the step to reverting 520 to the method from the step 510 of the method.

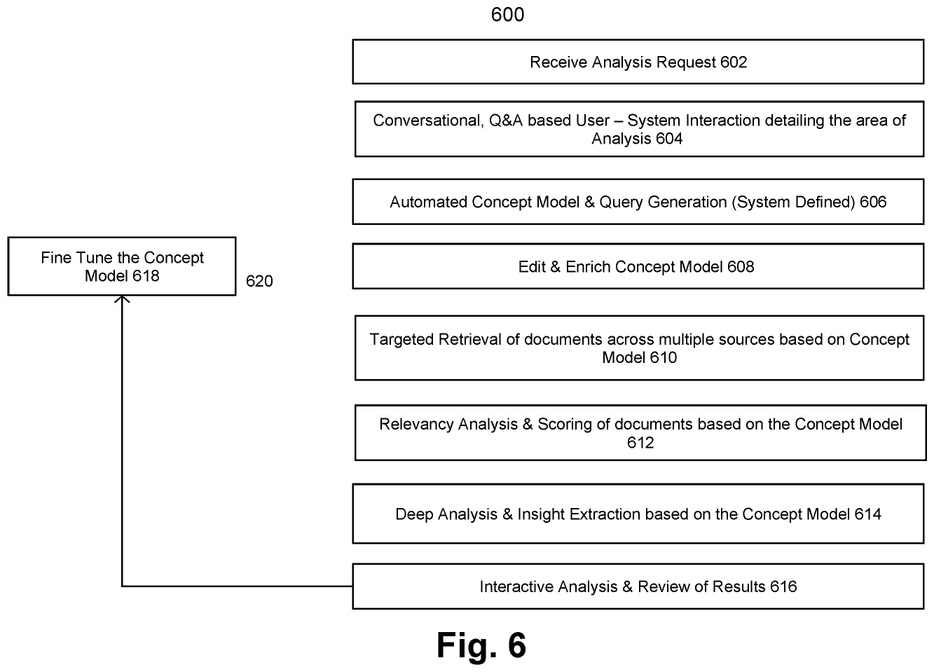

Referring now to FIG. 6, according to an embodiment of the invention, a machine-implemented method 600 for retrieval of a set of prioritized data. The method includes the steps of receiving 602 an analysis request, detailing an area of analysis 604 by conversational, question and answer based user-system interaction, generating 606 an automated concept model & query, editing 608 the concept model, targeted retrieving 610 of a set of documents across multiple sources based on the concept model, analyzing and extracting 614 insight based on the concept model: interactively analyzing & reviewing 616 of results. In case the result not found to be accurate, the method includes the step 618 of fine-tuning the concept model. In another embodiment of the present invention, the method 600, in case the result obtained are not found to be accurate, includes the step to reverting 620 to the step 610 of the method.

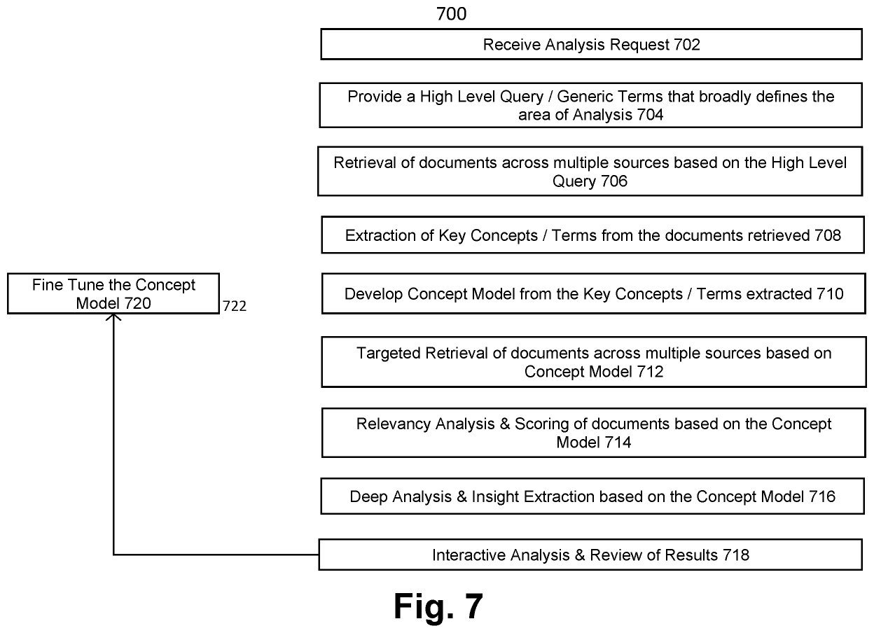

Referring now to FIG. 7, according to an embodiment of the invention, a machine-implemented method 700 for retrieval of a set of prioritized data. The method includes the steps of receiving 702 an analysis request, providing a first level query/generic terms 704 that broadly defines an area of analysis, retrieving 706 a first set of documents across multiple sources based on the first level query, extracting 708 key concepts/terms from the first set of documents retrieved, developing 710 a concept model from the key concepts/terms extracted, targeted retrieving 712 of a set of documents across multiple sources based on the concept model, relevancy analyzing and scoring 714 of the set of documents based on the concept model, analyzing and extracting 716 insight based on the concept model, interactively analyzing & reviewing 718 results. In another embodiment of the present invention, the method 700, in case the result obtained are not found to be accurate, includes the step to reverting 720 to the method from the step 710 of the method.

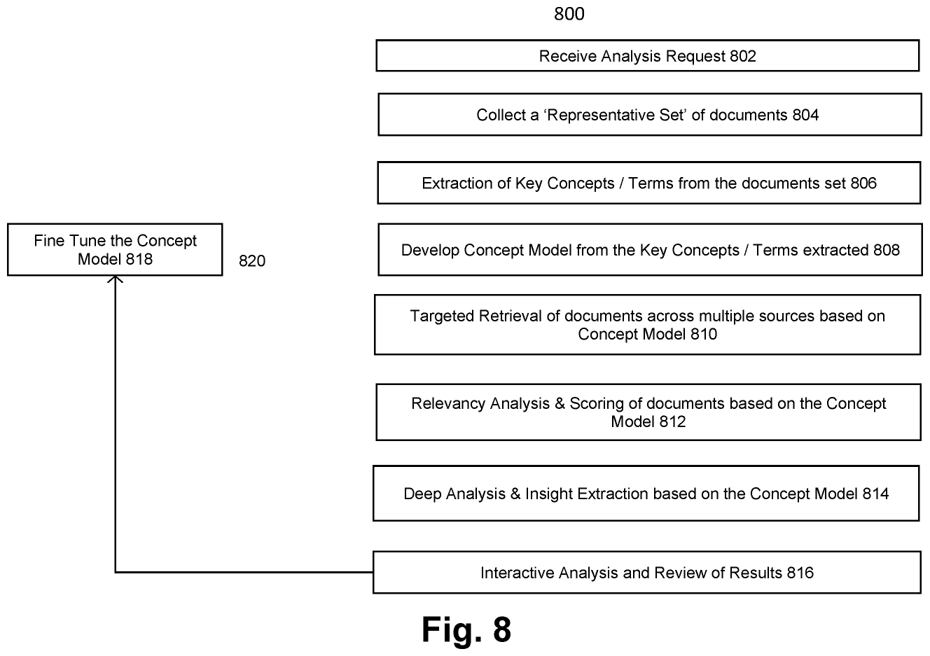

Referring now to FIG. 8, according to an embodiment of the invention, a machine-implemented method 800 for retrieval of a set of prioritized data. The method includes the steps of receiving 802 an analysis request, collecting 804 a initial set of documents, extraction 806 of key concepts/terms from the set of initial documents, developing 808 a concept model from the key concepts/terms extracted, targeted retrieving 810 of a targeted set of documents across multiple sources based on the concept model, relevancy analysis & scoring 812 of the set of documents based on the concept model, analyzing and extracting 814 insights based on the concept model, interactive analysis and review 816 of results. In case the result not found to be accurate, the method includes the step 818 of fine-tuning the concept model. In another embodiment of the present invention, the method 800, in case the result obtained are not found to be accurate, includes the step to reverting 820 to the method from the step 810 of the method.

The following example describes a process flow according to an embodiment of the invention.

### EXAMPLE 1

Step 1: A request from a user or an analyst was received.

Step 2: The scope and context of the analysis was elaborated.

Step 3: A concept model was developed. In this approach the user/analyst defined an area and scope of analysis though a concept model, which is a multi-dimensional, multi-level expression of the area of analysis.

Step 4: Enrich the concept model; the concept model was further enriched by the system though integration of dictionaries, industry specific ontology, synonyms and machine extracted relevant terms.

Step 5: Targeted retrieval of documents across multiple sources based on concept model was carried out. This was used to drive targeted retrieval of a set of documents content across multiple sources.

Step 6: Relevancy analysis and scoring of the set of documents based on the concept model was carried out.

Step 7: Deep analysis and insight extraction based on the concept model: the retrieved set of documents were processed and scored based on the concept model.

Step 8: Interactive analysis and review of result; the system also drives insight extraction based on the concept model and the results were made available to the user/analyst for interactive analysis and review.

Step 9: In case result not found to be proper, then the concept model was fine-tuned and then process started again from step 4.

The following example describes another process flow according to an embodiment of the invention.

### EXAMPLE 2

Step 1: a request from a user/analyst was received.

Step 2: A representative set of documents; the analyst uploads a set of initial documents, which are in the area of analysis and represents the area and scope of analysis well, was created.

Step 3: Automated concept model extraction: in this approach, the analyst may not be required to define a concept model. The system processed the set of initial documents and generated a concept model that represents the area of analysis.

Step 4: Edit and enrich the concept model: the concept model was edited or fine-tuned by the analyst. The concept model was further enriched by the system though integration of dictionaries, industry specific ontology, synonyms and machine extracted relevant terms.

Step 5: Targeted retrieval of a set of documents across multiple sources based on concept model was carried out. This was done to drive targeted retrieval of content across multiple sources.

Step 6: Relevancy analysis and scoring of the set of documents based on concept model was carried out; the retrieved content was processed and scored based on the concept model.

Step 7: Deep analysis based on the concept model was done and insights extracted from the analysis.

Step 8: Interactive analysis and review of result; the system also extracted insight based on the concept model and the results were made available to the user/analyst for interactive analysis and review.

Step 9: In case result was not found to be proper, then the concept model was fine-tuned and then process started again from step 4.

The following example describes another process flow according to an embodiment of the invention.

### EXAMPLE 3

Step 1: An analysis request was received.

Step 2: Conversational, question and answer based user-system interaction was done and an area of analysis was detailed.

Step 3: Automated Concept Model & Query Generation (System Defined) was carried out by the system.

Step 4: Concept Model was edited and enriched.

Step 5: Targeted Retrieval of a set of documents across multiple sources based on the Concept Model was carried out.

Step 6: Relevancy Analysis & Scoring of documents based on the Concept Model was done by the system.

Step 7: Deep Analysis based on the Concept Model was carried out and insights were extracted from the analysis.

Step 8: Interactive Analysis & Review of Results was done next.

Step 9: In case result was not found to be proper, then the concept model was fine-tuned and then process started again from step 5.

The following example describes another process flow according to an embodiment of the invention.

### EXAMPLE 4

Step 1: Analysis Request was received

Step 2: A first level query/generic terms that broadly defines an area of analysis was provided

Step 3: A first set of documents across multiple sources based on the first level query was retrieved.

Step 4: Extraction of Key Concepts/Terms from the first set of documents retrieved, was carried out.

Step 5: A Concept Model from the Key Concepts/Terms extracted, was developed.

Step 6: Targeted Retrieval of a set of documents across multiple sources based on the Concept Model was done.

Step 7: Relevancy Analysis & Scoring of the set of documents based on the Concept Model was next carried out.

Step 8: Deep Analysis based on the Concept Model was done and insights were extracted from the analysis.

Step 9: Interactive Analysis of Results was done and results were reviewed.

Step 10: In case result was not found to be proper, then the concept model was fine-tuned and then process started again from step 6.

The following example describes another process flow according to an embodiment of the invention.

### EXAMPLE 5

Step 1: An Analysis Request was received.

Step 2: A ‘Representative Set’ of documents were collected. A user or analyst uploaded a set of initial documents, representing an area and scope of analysis.

Step 3: Extraction of Key Concepts/Terms from the set of initial documents was carried out.

Step 4: A Concept Model from the Key Concepts/Terms extracted, was developed.

Step 5: Targeted Retrieval of a set of documents across multiple sources based on the Concept Model was carried out.

Step 6: Relevancy Analysis & Scoring of the set of documents based on the Concept Model was done next.

Step 7: Deep Analysis based on the Concept Model was done and insights extracted from the analysis.

Step 8: Interactive Analysis and Review of Results was carried out.

Step 9: In case result was not found to be proper, then the concept model was fine-tuned and then process started again from step 4.

What is claimed is:

1. A machine-implemented method for retrieval of a set of prioritized data, comprising:
a. obtaining a scope of analysis, prescribed either by a user or a system;
b. feeding the scope of analysis in a machine through an user interface
wherein, the machine is configured to augment the scope of analysis with a set of required information obtained by extracting relevant information from a preliminary data source;
c. creating a corpus of data from at least one data source based on the augmented scope of analysis;
d. processing the corpus of data by employing at least one parameter,
wherein, the at least one parameter is selected from at least one rule or a weightage based on the scope of analysis or a combination thereof to obtain a prioritized set of data.

2. The machine-implemented method of claim 1, wherein the preliminary data source is at least one answer to at least one query directed to the user.

3. The machine-implemented method of claim 1, wherein the preliminary data source is at least one answer to at least one query directed to a database.

4. The machine-implemented method of claim 1, wherein the preliminary data source is a set of documents related to a first level query that defines the scope of analysis.

5. The machine-implemented method of claim 1, wherein the preliminary data source is a set of documents provided by the user.

6. The machine-implemented method of claim 1, wherein scope of analysis comprises a query, multilevel keywords, flexible keywords, or rules on sourcing.

7. The machine-implemented method of claim 1, wherein machine can be computer, server and the like.

8. The machine-implemented method of claim 1, wherein augmented scope of analysis may be a multi-dimensional expression, a hierarchical property structure, a database or a collection of terms.

9. The machine-implemented method of claim 1, wherein corpus of data may be dynamic or static or both.

10. The machine-implemented method of claim 1, wherein the data source may include unstructured and semi structured information.

11. The machine-implemented method of claim 1, wherein processing involves ranking, annotation, classification, correlation, retrieval, entity and insight extraction or interactive analysis.

12. The machine-implemented method of claim 1, further comprising the step of fine-tuning the augmented scope of analysis.

13. The machine-implemented method of claim 1, further comprising the step of extracting insights from the set of prioritized data, comprising:
a. identifying at least one entity from the set of prioritized data;
b. identifying at least one event from the set of prioritized data;
c. identifying at least one relationship between two or more of the at least one entity, two or more of the at last one event, or a combination thereof, and
d. presenting the at least one relationship.

14. The method of claim 12, wherein the at least one entity comprises a person, an organization, a location, a product, a technology, a chemical, a material, a property of a material, a process, an application or a combination thereof.

15. The method of claim 12, wherein the at least one event comprises a business acquisition, a product launch, a plant opening, a merger, a business announcement, a research initiative, a collaboration, or a combination thereof.

16. The method of claim 12, wherein the step of presenting the at least one relationship between the at least one entity and the at least one event comprises presenting a graphical representation of the at least one relationship, presenting a tabular representation of the at least one relationship, presenting a pictorial representation of the at least one relationship, a statistical representation of the at least one relationship, or combinations thereof.

17. A machine-implemented method for extraction of insights from a set of prioritized data, comprising:
a. identifying at least one entity from the set of prioritized data;
b. identifying at least one event from the set of prioritized data;
c. identifying at least one relationship between two or more of the at least one entity, two or more of the at last one event, or a combination thereof, and
d. presenting the at least one relationship.

18. A machine-implemented method for extraction of insights from a set of prioritized data, comprising:
a. obtaining a scope of analysis, prescribed either by a user or a system;
b. feeding the scope of analysis in a machine through a user interface
wherein, the machine is configured to augment the scope of analysis with a set of required information to create an augmented scope of analysis;
c. creating a corpus of data from at least one data source based on the augmented scope of analysis;
d. processing the corpus of data employing at least one parameter,
selected from at least one rule or a weightage based on the scope of analysis or a combination thereof to obtain a prioritized set of data;
e. identifying at least one entity from the set of prioritized data;
f. identifying at least one event from the set of prioritized data;
g. identifying at least one relationship between two or more of the at least one entity, two or more of the at last one event, or a combination thereof, and
h. presenting the at least one relationship.

19. The machine-implemented method for extraction of insights from a set of prioritized data according to claim 17, wherein the machine-implemented method is a computer-implemented method.

20. The machine-implemented method for extraction of insights from a set of prioritized data according to claim 17, wherein the set of required information to create an augmented scope of analysis is based on a multi-dimensional expression or a hierarchical property structure or a combination thereof.
